(19) United States
(12) Patent Application Publication
(10) Pub. No.: US 2019/0195308 A1
(43) Pub. Date: Jun. 27, 2019

(54) Frequency-Dependent Damping Valve Arrangement

(71) Applicant: ZF FRIEDRICHSHAFEN AG, Friedrichshafe (DE)

(72) Inventor: Andreas FÖRSTER, Schweinfurt (DE)

(21) Appl. No.: 16/331,480

(22) PCT Filed: Aug. 3, 2017
(86) PCT No.: PCT/EP2017/069587

§ 371 Date: Mar. 7, 2019

(30) Foreign Application Priority Data
Sep. 8, 2016 (DE) 10 2016 217 112.7

(51) Int. Cl. F16F 9/348; F16F 9/512

(52) U.S. Cl. CPC F16F 9/3485; F16F 2226/045; F16F 9/5126

(57) ABSTRACT

A frequency-dependent damping valve arrangement including a damping piston with a check valve arranged inside a cylinder filled with a damping fluid; a control arrangement arranged at a carrier coaxial to the damping piston having a control pot and a control piston arranged in the control pot and axially displaceable at the carrier; a first end stop for limiting the axial movement of the control piston inside of the control pot. The end stop has a supporting disk and an adjusting disk. The adjusting disk is irreversibly plastically deformable and has a lower yield limit than supporting disk and/or the carrier. The axial end position of the control piston is adjustable by a plastic deformation of the adjusting disk. At least one of the structural component parts defines a free space for receiving the material of the adjusting disk which is displaced through the plastic deformation.

### CROSS-REFERENCE TO RELATED APPLICATIONS

This is a U.S. national stage of application No. PCT/EP2017/069587, filed on Aug. 3, 2017. Priority is claimed on German Application No. DE102016217112.7, filed Sep. 8, 2016, the content of which is incorporated herein by reference.

### BACKGROUND OF THE INVENTION

### 1. Field of the Invention

The invention is directed to a damping valve arrangement of a vibration damper for a motor vehicle with a frequency-dependent damping force characteristic.

### 2. Description of the Prior Art

A vibration damper in a motor vehicle is to damp the vibrations excited by the uneven road surface. In doing so, it is always necessary to find a compromise between driving safety and driving comfort. A vibration damper having a damping valve device adjusted to be hard and a high damping force characteristic is optimal for highly safe driving. If there is a high demand for comfort to be met, the damping valve device should be adjusted to be as soft as possible. It is very difficult to find this compromise in a vibration damper with a conventional damping valve device which is adjustable without the help of an electronic actuator.

A generic damping valve arrangement with a frequency-dependent damping force characteristic is known from DE 10 2014 210 704. This damping valve arrangement comprises a damping valve arranged inside a cylinder filled with a damping medium and which has at least one flow channel covered by at least one valve disk. The damping valve arrangement further comprises a control arrangement mounted coaxial to the damping valve and comprising a control pot with an axially displaceable control piston arranged in the control pot. The control piston axially limits a control space enclosed in the control pot and connected to the damping valve arrangement via an inlet connection. A spring element which axially introduces a spring force into the control piston on the one hand and into the damping valve on the other hand is arranged between the control piston and the damping valve. When the control space is filled with damping medium, the control piston displaces in direction of the damping valve and, via the spring element, increases the pressing pressure of the valve disk of the damping valve, which increases the damping force.

A distinction is made between a soft damping force characteristic and a hard damping force characteristic, the latter designating a damping force characteristic that results when the control piston comes in contact with one of the end stops and accordingly reaches its axial end position. A soft damping force characteristic is one that is generated when the control piston comes in contact with the first end stop which faces the pot base. When the control space is filled with damping medium, the control piston moves in direction of the damping valve. This movement can last at most until the control piston comes in contact with the second end stop that faces the damping valve. The damping force characteristic generated in this state will be referred to in the following as hard damping force characteristic.

In the vibration dampers mentioned above, it is generally very difficult to adjust the soft damping force characteristic and the hard damping force characteristic without additional controlling.

It is known from DE 10 2014 210 704 that the hard characteristic can be adjusted through the plastic deformation of an adjusting disk serving as end stop.

The adjusting disk is arranged between a supporting disk and a radial projection, i.e., a shoulder formed at the carrier sleeve and supported axially at the latter. The adjusting disk projects radially beyond the shoulder of the carrier because it cannot be produced to be sufficiently narrow for technical reasons pertaining to stamping and cannot therefore be produced economically. For this reason, when compressed, the adjusting disk undergoes radial forces outward, which radial forces also increase its inner diameter and cause the adjusting disk to slide out, which makes it appreciably harder to adjust the hard damping force characteristic accurately. However, a one-sided sliding-out is fostered when the adjusting disk is not arranged centric to the corresponding deformation surfaces.

### SUMMARY OF THE INVENTION

It is the object of one aspect of the present invention to provide an alternative frequency-selective damping valve arrangement which offers a possibility for minimizing a radial sliding-out of the adjusting disk during the defined plastic deformation of the adjusting disk and for adjusting the hard damping force characteristic in a defined manner.

According to one aspect of the invention, at least one of the structural component parts comprising supporting disk and/or carrier defines a free space for receiving the material of the adjusting disk that is displaced through the plastic deformation. In this way, some of the deformed material of the adjusting disk can be displaced radially inward so that the effect of an enlargement of the inner diameter of the adjusting disk and the radial sliding-out of the adjusting disk is appreciably reduced.

According to an advantageous constructional variant, the carrier has a radial shoulder. Accordingly, the adjusting disk can be axially supported at the carrier in a simple manner. It can also be provided to place a further supporting disk between the shoulder and the adjusting disk, which would enlarge or reduce or in some other defined manner modify the supporting surface.

When the carrier has a conical portion arranged adjoining the shoulder as is suggested according to a further advantageous constructional variant, the adjusting disk can be centered at the carrier in a very simple and precise manner.

According to a further advantageous constructional variant, the supporting disk can have at least one recess which radially and/or axially limits the free space.

Alternatively or additionally, the free space can be arranged between the conical portion and the shoulder or also between the conical portion and the inner diameter of the adjusting disk.

According to a further advantageous constructional variant, the supporting disk can have at least one angled edge portion which radially limits the free space. The angled edge portion can be arranged at the radially inner edge or radially outer edge of the supporting disk and can be constructed so as to extend circumferentially uninterruptedly in circumferential direction.

### BRIEF DESCRIPTION OF THE DRAWINGS

The invention will now be described in more detail referring to the figures. The drawings show:

FIG. 1 is a sectional view of an exemplary constructional variant of a frequency-dependent damping valve arrangement in a cylinder of a vibration damper;

FIG. 2 is a top view of an exemplary constructional variant of a supporting disk;

FIG. 3 is a side view of an exemplary constructional variant of a supporting disk according to the invention;

FIG. 4 is a sectional view of an exemplary constructional variant of a carrier according to the invention;

FIG. 5 is a detailed view of a free space in the carrier according to FIG. 4;

FIG. 6 is a detailed enlarged sectional view of an exemplary constructional variant of an end stop; and

FIG. 7 is a detailed enlarged sectional view of a further exemplary constructional variant of an end stop.

### DETAILED DESCRIPTION OF THE PRESENTLY PREFERRED EMBODIMENTS

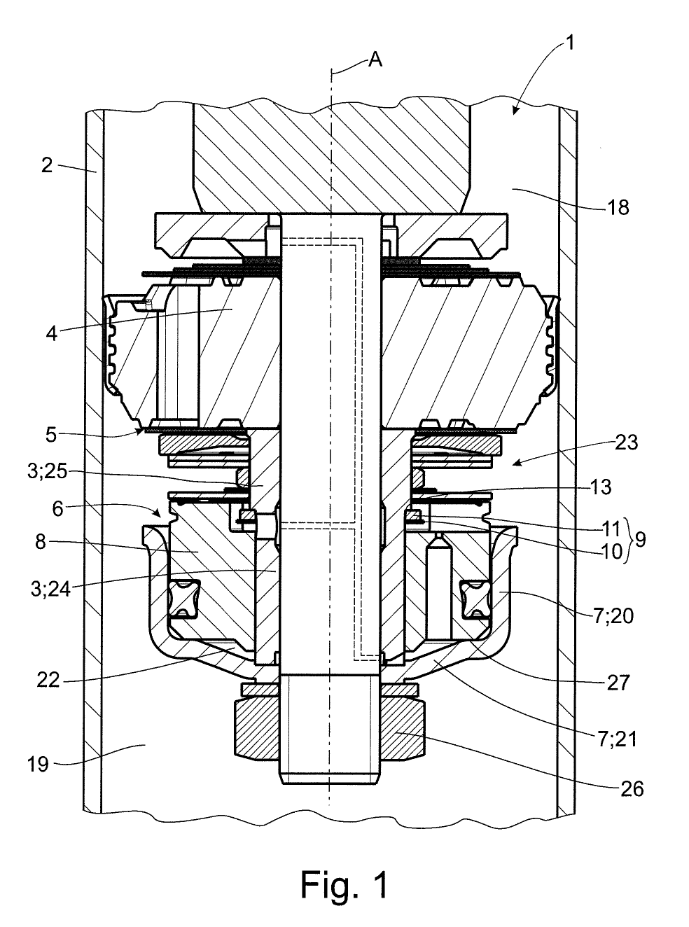

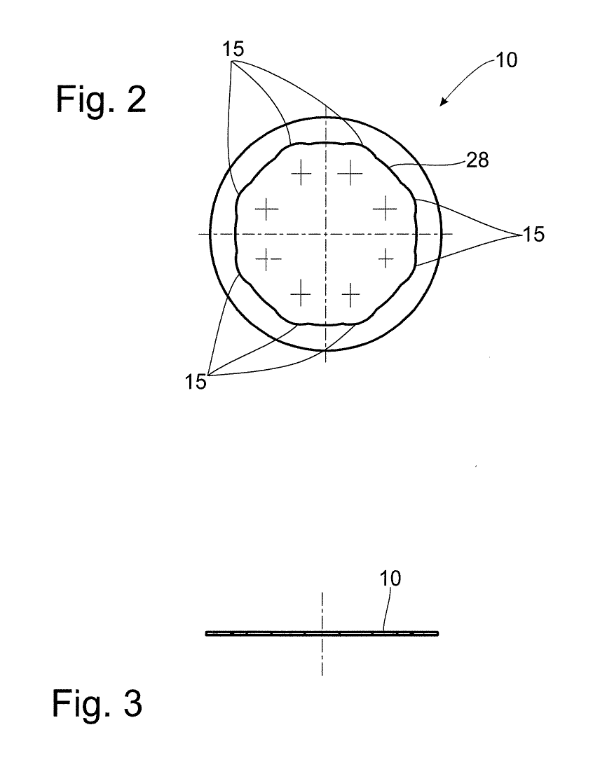

FIG. 1 shows a portion of a vibration damper for a motor vehicle with a frequency-dependent damping valve arrangement 1 according to one aspect of the invention in a sectional view.

The damping valve arrangement 1 comprises a cylinder 2 at least partially filled with a damping fluid.

The damping valve arrangement 1 is axially displaceably arranged inside the cylinder 2 and is fastened to a piston rod. Damping valve arrangement 1 comprises a damping piston 4 with at least one check valve 5 having at least one flow channel formed therein for the damping fluid, which flow channel is covered by at least one valve disk.

Damping piston 4 divides a first working chamber 18 from a second working chamber 19 inside cylinder 2 such that the ratio of the damping medium pressure in the two working chambers 18, 19 varies depending on the direction of axial movements of damping piston 4 in cylinder 2.

Further, damping valve arrangement 1 has a control arrangement 6 that contains a control pot 7 with a cylindrical pot wall 20 and a disk-shaped pot base 21 and with a control piston 8 which is axially displaceably arranged in control pot 7 and axially limits a control space 22 enclosed in control pot 7.

A spring arrangement 23 impinges with a defined spring force upon check valve 5 axially in direction of damping piston 4 and upon control piston 8 in direction of pot base 21 is arranged between damping piston 4 and control arrangement 5.

All of the structural component parts of the control arrangement 6 are arranged coaxial to one another at carrier 3. As is shown in FIG. 1, damping valve arrangement 1 is constructed such that carrier 3 is constructed as a guide sleeve and extends centrally through spring arrangement 23 and control piston 8. Carrier 3 comprises a first guide portion 24 and a second guide portion 25 axially adjoining the latter. Control piston 8 can slide axially along first guide portion 24, and spring arrangement 23 can slide axially along second guide portion 25. The direction of the axial movements of control piston 8 depend upon the damping medium pressure in control space 22.

Control pot 7 of control arrangement 6 is connected to carrier 3 in the area of pot base 21 with the aid of connection 26. Connection 26 is shown in FIG. 1 as a threaded nut. It will be appreciated that connection 26 can also have a different suitable constructional form. In general, the connection between carrier 3 and control pot 7 can be carried out by bonding engagement and/or positive engagement and/or frictional engagement.

Control piston 8 is arranged inside control pot 7 and constructed so as to be axially displaceable so that when a damping fluid pressure persists over a longer period of time in control space 22 of control arrangement 6 the control piston 8 is displaced in direction of check valve 5 and can tighten spring arrangement 23 so that the spring force acting on check valve 5 through spring arrangement 23 and, therefore, the damping force of check valve 5 are increased.

A first end stop 9 and a second end stop 27 are formed at control arrangement 6 to define the soft damping force characteristic and the hard damping force characteristic. In the constructional variant depicted in FIG. 1, first end stop 9 is formed of two parts and comprises an adjusting disk 11 and a supporting disk 10. In contrast, second end stop 27 is constructed as an at least partial ridge of pot base 21. It will be appreciated that second end stop 27 can also be formed as a stop ring or as an additional stop element, which can be arranged inside of control space 22.

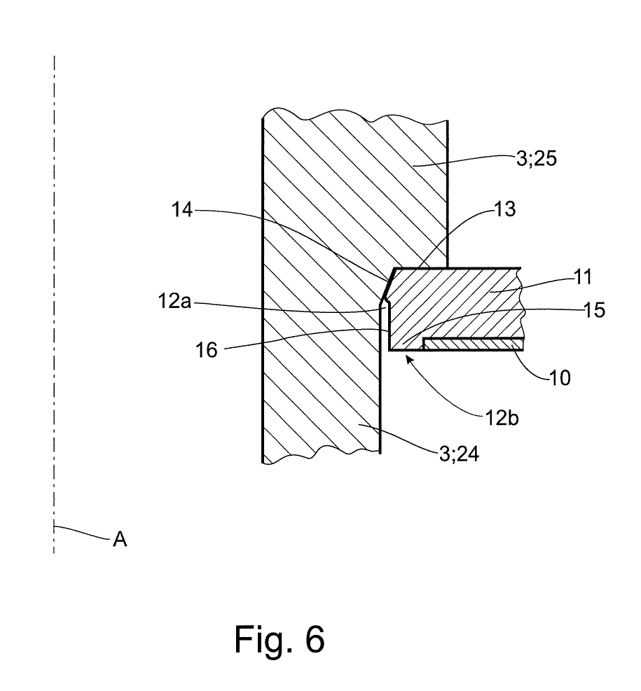

As has already been explained, damping valve arrangement 1 according to one aspect of the invention provides that end stop 9 comprises a supporting disk 10 and an adjusting disk 11. Adjusting disk 11 is irreversibly plastically deformable and has a lower yield limit than supporting disk 10 and/or carrier 3. FIG. 6 shows a plastically deformable adjusting disk 11. The material of adjusting disk 11 which is displaced through the plastic deformation has been received by free spaces 12a and 12b. Free space 12a has been radially limited by the carrier on the one side, and free space 12b has been limited by a recess 15 in supporting disk 10.

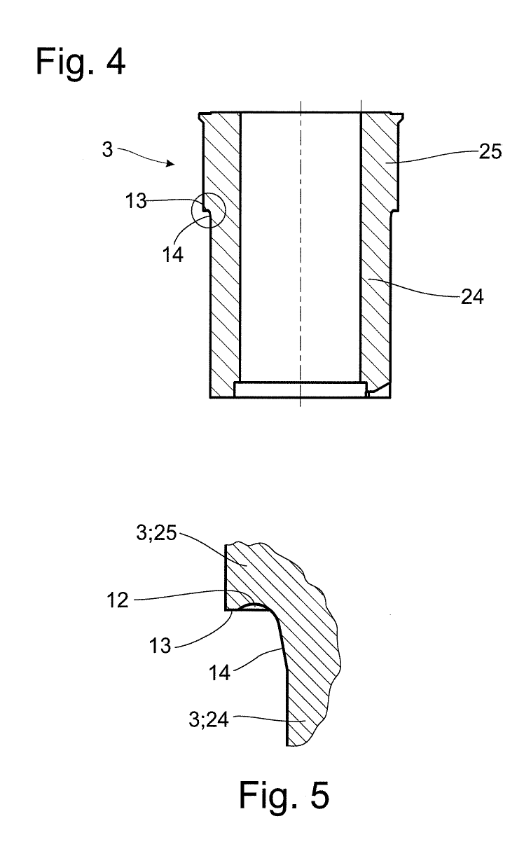

As is shown in FIGS. 4, 5, 6 and 7, a radial shoulder 13 is formed at carrier 3, and the adjusting disk contacts this radial shoulder 13 axially with respect to longitudinal axis A. Further, carrier 3 has a conical portion 14, which is arranged adjoining shoulder 13 and which serves to make the centering of adjusting disk 11 at carrier 3 more precise.

According to the constructional variant shown in FIGS. 4 and 5, free space 12 can be arranged between conical portion 14 and shoulder 13.

It is also possible to form free space 12a, 12b between conical portion 14 and inner edge 16 of adjusting disk 11 and/or at recess 15 formed at supporting disk 10 as is shown in FIG. 6. Recesses 15 can be formed at inner edge 28 of supporting disk 10 or also at another suitable position at supporting disk 10.

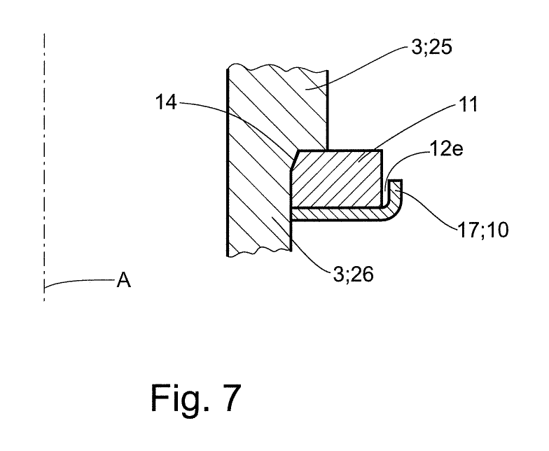

FIG. 7 shows a further constructional variant according to which free space 12 is radially limited by an angled edge portion 17 formed at supporting disk 10. The angled edge portion 17 can be formed so as to extend circumferentially uninterruptedly in circumferential direction or can also be formed of individual segments.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-10. (canceled)

11. A frequency-dependent damping valve arrangement of a vibration damper, comprising:
a damping piston with a check valve, and arranged inside of a cylinder that is at least partially filled with a damping fluid;
a carrier;
a control arrangement arranged at the carrier and coaxial to the damping piston that comprises:
a control pot; and
a control piston arranged in the control pot and is slidingly axially displaceable at carrier;
at least a first end stop configured to limit an axial movement of the control piston inside the control pot, that comprises:
a supporting disk; and
an adjusting disk that is irreversibly plastically deformable and has a lower yield limit than supporting disk and/or carrier, and
wherein an axial end position of the control piston is adjustable by a plastic deformation of the adjusting disk,
wherein at least one of the supporting disk and/or the carrier defines a free space configured to receive a material of the adjusting disk that is displaced through the plastic deformation.

12. The frequency-dependent damping valve arrangement according to claim 11, wherein the carrier has a radial shoulder for axial contact of the adjusting disk at the carrier.

13. The frequency-dependent damping valve arrangement according to claim 12, wherein the carrier has a conical portion arranged adjoining the shoulder configured to center the adjusting disk at the carrier.

14. The frequency-dependent damping valve arrangement according to claim 11, wherein the free space is limited by at least one recess formed at the supporting disk.

15. The frequency-dependent damping valve arrangement according to claim 13, wherein the free space is arranged between the conical portion and the shoulder.

16. The frequency-dependent damping valve arrangement according to claim 13, wherein the free space is arranged between the conical portion and an inner edge of the adjusting disk.

17. The frequency-dependent damping valve arrangement according to claim 11, wherein the supporting disk has at least one angled edge portion which radially limits the free space.

18. The frequency-dependent damping valve arrangement according to claim 17, wherein the angled edge portion is constructed so as to extend circumferentially uninterruptedly in circumferential direction.

19. Vibration damper for a motor vehicle, comprising:
a cylinder that is at least partially filled with a damping fluid; and
a vibration damper, comprising:
a damping piston with a check valve, and arranged inside of the cylinder;
a carrier;
a control arrangement arranged at the carrier and coaxial to the damping piston that comprises:
a control pot; and
a control piston arranged in the control pot and is slidingly axially displaceable at carrier;
at least a first end stop configured to limit an axial movement of the control piston inside the control pot, that comprises:
a supporting disk; and
an adjusting disk that is irreversibly plastically deformable and has a lower yield limit than supporting disk and/or carrier, and
wherein an axial end position of the control piston is adjustable by a plastic deformation of the adjusting disk,
wherein at least one of the supporting disk and/or the carrier defines a free space configured to receive a material of the adjusting disk that is displaced through the plastic deformation.

20. Motor vehicle, comprising
at least one vibration damper comprising:
a cylinder that is at least partially filled with a damping fluid; and
a vibration damper, comprising:
a damping piston with a check valve, and arranged inside of the cylinder;
a carrier;
a control arrangement arranged at the carrier and coaxial to the damping piston that comprises:
a control pot; and
a control piston arranged in the control pot and is slidingly axially displaceable at carrier;
at least a first end stop configured to limit an axial movement of the control piston inside the control pot, that comprises:
a supporting disk; and
an adjusting disk that is irreversibly plastically deformable and has a lower yield limit than supporting disk and/or carrier, and
wherein an axial end position of the control piston is adjustable by a plastic deformation of the adjusting disk,
wherein at least one of the supporting disk and/or the carrier defines a free space configured to receive a material of the adjusting disk that is displaced through the plastic deformation.
